(19) United States
(12) Patent Application Publication
(10) Pub. No.: US 2008/0226290 A1
(43) Pub. Date: Sep. 18, 2008

(54) OPTICAL SIGNAL MONITORING APPARATUS, OPTICAL SYSTEM AND OPTICAL SIGNAL MONITORING METHOD

(75) Inventors: Takaharu Ohyama, Atsugi-shi (JP); Takashi Goh, Atsugi-shi (JP); Shin Kamei, Atsugi-shi (JP); Shunichi Sohma, Atsugi-shi (JP); Mikitaka Itoh, Atsugi-shi (JP); Ikuo Ogawa, Atsugi-shi (JP); Akimasa Kaneko, Atsugi-shi (JP); Tomoyuki Yamada, Tokyo (JP); Mitsuru Nagano, Tokyo (JP); Yoshiyuki Doi, Tokyo (JP); Takashi Saida, Tokyo (JP)

Correspondence Address: WORKMAN NYDEGGER, 60 EAST SOUTH TEMPLE, 1000 EAGLE GATE TOWER, SALT LAKE CITY, UT, 84111, US

(73) Assignees: Nippon Telegraph and Telephone Corporation, Tokyo (JP); NTT Electronics Corporation, Tokyo (JP)

(21) Appl. No.: 12/042,767

(22) Filed: Mar. 5, 2008

(30) Foreign Application Priority Data
Mar. 6, 2007 (JP) 2007-056010

(51) Int. Cl. H04B 10/08

(52) U.S. Cl. 398/34

(57) ABSTRACT

By reducing the number of PD arrays, and by simplifying the configuration of an optical power monitor in a WDM system, a miniaturized, cost reduced optical signal monitoring apparatus, optical system or optical signal monitoring method is provided. An optical power monitor 1 has an optical switch 30 having four input ports 31, a DMUX 2 having 48 output ports, and six CSP type PD array modules 50 each including an 8-channel PD array. The output port 32 of the optical switch 30 having four switchable input ports 31 is optically connected to the input port 21 of the AWG 20. The 48 output ports 22 of the AWG 20 are each optically connected to photosensitive surfaces 53 of the individual PDs included in the CSP type PD array modules 50. The CSP type PD array modules 50 are mounted on the end face of the AWG 20.

This application claims priority to Japanese Patent Application No. 2007-056010, filed Mar. 6, 2007, which is hereby incorporated by reference herein in its entirety.

### BACKGROUND OF THE INVENTION

1. Field of the Invention

The present invention relates to an optical signal monitoring apparatus, an optical system and an optical signal monitoring method, and more particularly to an optical signal monitoring apparatus, an optical system and an optical signal monitoring method used in optical fiber communications including a WDM system for handling a plurality of light wavelength signals.

2. Description of the Related Art

As communication capacity increases recently, optical transmission systems using wavelength division multiplexing (WDM) technology have been widely introduced into regions from backbones to metro areas. The WDM systems constructed from these optical transmission systems carry out quality control of transmission signals, system control and the like with monitoring optical signals of individual wavelength channels.

As an example of such a WDM system, there is an ROADM (Reconfigurable Optical Add Drop Multiplexer) system, which has been introduced remarkably recently. It is a WDM system that has a plurality of nodes connected in a ring, and enables each node to extract or insert an optical signal from or into a desired wavelength channel. Since the ROADM system is normally duplexed in clockwise and counterclockwise directions of a transmission ring, the signal channels are duplexed in the individual nodes.

FIG. 1 shows a basic structure of a node and conventional optical power monitors. The node has a wavelength demultiplexer (DMUX) 100, a wavelength multiplexer (MUX) 101, and an optical switch 102. A WDM signal (signal consisting of a plurality of light wavelength signals multiplexed) is demultiplexed to individual light wavelength signals through the DMUX 100. After that, by operating the optical switch 102, the signal with a desired light wavelength can be extracted or passed through the node as it is. In addition, a light wavelength signal to be inserted to a node from outside can be inserted into the node via the optical switch 102. The light wavelength signal passing through the optical switch 102 as it is or the light wavelength signal inserted into the node via the optical switch 102 is multiplexed again by the MUX 101 to be sent as the WDM signal from the node.

To carry out the signal processing or system control in such an ROADM system, it is necessary to monitor the optical signal of each wavelength channel. For example, the power of the optical signal of each wavelength channel is given as one of the monitoring items.

FIG. 1 shows an example that monitors the power of the optical signal of each wavelength channel at an inlet of the node ((1) and (3) in FIG. 1) or at an outlet of the node ((2) and (4) in FIG. 1). In FIG. 1, each portion enclosed with broken lines is a portion constituting an optical power monitor 1. Part of the WDM signal split through a coupler 103 at the inlet or outlet of the node is supplied to a DMUX 2 of an optical power monitor 1 to be demultiplexed to individual wavelengths, and received by photodiodes (PDs) 3 placed for individual channels to be monitored. As an example of components of such an optical power monitor 1, a dielectric multilayer filter or an arrayed waveguide grating multi-demultiplexer (AWG) is applicable to the DMUX 2. In addition, to the PDs 3 is applicable a component that arranges CAN package type PD modules by the number of the wavelength channels, or a chip scale package (CSP) type PD array module recently.

FIG. 2 shows a structure of a CSP type PD array module 50 (see Japanese Patent Laid-Open No. 2006-128514). The CSP type PD array module 50 includes a ceramic casing 51, a glass window 52, and a PD array 54 which has a plurality of photosensitive surfaces 53 and is hermetically sealed with solder. It is much smaller than the PD array module consisting of a plurality of CAN package PD modules arranged.

As an example of the optical power monitor 1, a 40-channel optical power monitor has been developed so far which has a CSP type PD array module 50 fixed directly on end faces of output waveguides 22 of a silica glass AWG 20. FIG. 3 shows a structure of the optical power monitor that comprises the AWG 20 having 40 output ports (waveguides) 22, and five CSP type PD array modules 50 each including 8-channel PD array 54. Here, the pitch of the output waveguides 22 of the AWG 20 equals the pitch of the photosensitive surfaces 53 of the PD array 54, and each CSP type PD array module 50 is mounted in such a manner as to be optically connected to the end faces of the output waveguides 22 of the AWG (see Oyama et al. “40-ch optical power channel monitor module using AWG and CSP-PD array”, Proceedings of the 2006 IEICE Electronics Society Conference 1, C-3-78, page 200).

The conventional optical power monitor requires the same number of PDs as the wavelength channels required by the WDM system. For example, to construct a 48-channel optical power monitor 1 in the same manner as described above, 48 PDs are required. If the CSP type PD array modules 50 each including the 8-channel PD array 54 are used in this case, six modules must be mounted on the output waveguides 22 of the AWG 20. Thus, it takes much time to assemble them, offering a problem of increasing the cost of manufacturing. In addition, since the layout of the output waveguides 22 of the AWG 20 must be put around for each CSP type PD array module 50, a problem arises of increasing the chip size of the AWG 20. Furthermore, as for electronic components such as logarithmic amplifiers that are normally placed after the PDs 3, they must be prepared by the number of channels (48 in this case). Thus, it has a problem of incurring costs because of an increasing number of components on a board on which these components are integrated, and because of increasing the size of the board.

Besides, in the conventional technology, the optical power monitors must be placed at individual positions at which the WDM optical signal is to be monitored in the node. More specifically, as shown in FIG. 1, the optical power monitors must be placed at four positions (1)-(4) of FIG. 1. Here, for the sake of convenience, a node that constitutes a ROADM system with the 48 wavelength channels is supposed. In addition, let us take as an example of the optical power monitor 1, a configuration that employs an AWG as the DMUX 2 and an 8-channel CSP type PD array module as the PDs 3. In this case, since the optical power monitors are placed at four locations, the number of the AWGs 20 required is four and the number of the 8-channel CSP type PD array modules 50 is required as many as 24. In addition, as for the electronic components such as logarithmic amplifiers normally placed after the PD3, they are required by the number of the channels of the PDs 3.

As described above, in the conventional technology, the optical power monitor modules must be placed at individual locations at which the monitoring is necessary in the node. Thus, an increasing number of components offer a problem of incurring high cost. In addition, since the space the optical power monitors 1 occupy in the node is large, a problem arises in that the apparatus itself becomes large in size.

### SUMMARY OF THE INVENTION

The present invention is implemented to solve the foregoing problems of the conventional technology. It is therefore an object of the present invention to provide a miniaturized, cost reduced optical signal monitoring apparatus, optical system or optical signal monitoring method capable of reducing the number of the PD arrays of the optical signal monitoring apparatus and capable of simplifying the configuration of the optical signal monitoring apparatus in the WDM system.

To accomplish the objects, the optical signal monitoring apparatus in accordance with the present invention comprises: an optical switch with at least one of input port and output port in plural form; a wavelength demultiplexer that has at least one input port and a plurality of output ports, and has its input port optically connected to the output port of the optical switch; and a photo diode array mounted on the output ports of the wavelength demultiplexer.

In the optical signal monitoring apparatus, the output ports of the wavelength demultiplexer and the photo diode array may be implemented via an optical path conversion mirror.

The optical signal monitoring apparatus may have the plurality of photo diodes consisted of the photo diode array optically connected to the output ports of the wavelength demultiplexer being spaced at a prescribed wavelength channel interval.

The optical signal monitoring apparatus may have dummy photo diodes placed among the plurality of photo diodes consisted of the photo diode array.

An optical system in accordance with the present invention, which has a configuration of monitoring at a plurality of positions a WDM signal with a plurality of wavelength signals being multiplexed, comprises: a plurality of branching sections for branching a part of the WDM signal at each monitoring position; and the foregoing optical signal monitoring apparatus, which is optically connected to each of the plurality of branching sections respectively.

The present invention is provided with the optical switch having a plurality of inputs and at least one output, and the AWG having at least one input and a plurality of outputs. Thus, it can monitor optical signals from a plurality of monitoring positions using common PDs by placing the input of the optical switch to the input connected to a desired position to be monitored.

In addition, the present invention is provided with the optical switch having at least one input and a plurality of outputs, and the AWG having a plurality of inputs and a plurality of outputs. Thus, it can monitor optical signals with different wavelengths using common PDs by switching the input of the AWG by switching the output of the optical switch.

Furthermore, the present invention is provided with the optical switch having a plurality of inputs and a plurality of outputs, and the AWG having a plurality of inputs and a plurality of outputs. Thus, it can monitor optical signals with different wavelengths fed from a plurality of monitoring positions using common PDs by placing the input of the optical switch at the input connected to a desired position to be monitored, and by switching the input of the AWG by switching the output of the optical switch.

Thus, it can greatly reduce the numbers of the AWGs and the PDs, thereby being able to implement the miniaturized, cost reduced WDM system.

The present invention can simplify the construction of the optical signal monitoring apparatus in the WDM system with maintaining the capability of monitoring the WDM signal at a plurality of positions, and can implement the miniaturized, cost reduced apparatus by reducing the number of the PD arrays of the optical signal monitoring apparatus.

Further features of the present invention will become apparent form the following description of exemplary embodiments (with reference to the attached drawings).

### BRIEF DESCRIPTION OF THE DRAWINGS

FIG. 1 is a block diagram showing a basic structure of a node and conventional optical power monitors;

FIG. 2 is a perspective view showing a configuration of a CSP type PD array module;

FIG. 3 is a plan view showing a configuration of the conventional optical power monitor;

FIG. 4 is a plan view showing a configuration of an optical power monitor of an embodiment 1 in accordance with the present invention;

FIG. 5 is a block diagram showing a basic structure of a node and the optical power monitor of the embodiment 1 in accordance with the present invention;

FIG. 6 is a plan view showing a configuration of the optical power monitor of an embodiment 2 in accordance with the present invention;

FIG. 7 is a plan view showing a basic structure of an AWG;

FIG. 8A is a diagram showing input/output waveguides substantially functioning in all the input/output waveguides of the AWG used in the embodiment 2;

FIG. 8B is a diagram showing only the input/output waveguides substantially functioning in the AWG used in the embodiment 2;

FIG. 9 is a plan view showing a configuration of the optical power monitor of an embodiment 3 in accordance with the present invention;

FIG. 10A is a diagram showing occurrence factors of cross talk of the optical power monitor of the embodiment 3;

FIG. 10B is a diagram showing a first configuration of reducing the cross talk of the optical power monitor of the embodiment 3;

FIG. 11A is a diagram showing a second configuration of reducing the cross talk of the optical power monitor of the embodiment 3;

FIG. 11B is a cross-sectional view taken along the line XIB-XIB′ of the optical power monitor of the embodiment 3;

FIG. 12 is a plan view showing a configuration of the optical power monitor of an embodiment 4 in accordance with the present invention;

FIG. 13 is a plan view showing a configuration of the optical power monitor of an embodiment 5 in accordance with the present invention;

FIG. 14 is a block diagram showing a basic structure of a node and the optical power monitor of the embodiment 5 in accordance with the present invention;

FIG. 15A is a plan view showing a basic structure of an optical switch based on a PLC;

FIG. 15B is a cross-sectional view taken along the line XVB-XVB of the optical switch based on the PLC;

FIG. 16 is a table showing the relationship of FIGS. 16A and 16B;

FIG. 16A is a table showing relationships between the input/output ports of the AWG and output wavelengths;

FIG. 16B is a table showing relationships between the input/output ports of the AWG and output wavelengths;

FIG. 17 is a table showing the relationship of FIGS. 17A and 17B;

FIG. 17A is a table showing relationships between substantially functioning input/output ports of the AWG and the output wavelengths in the embodiment 2 in accordance with the present invention;

FIG. 17B is a table showing relationships between substantially functioning input/output ports of the AWG and the output wavelengths in the embodiment 2 in accordance with the present invention;

FIG. 18 is a table showing the relationship of FIGS. 18A and 18B;

FIG. 18A is a table showing the relationships between the substantially functioning input/output ports of the AWG and the output wavelengths in the embodiment 2 in accordance with the present invention;

FIG. 18B is a table showing the relationships between the substantially functioning input/output ports of the AWG and the output wavelengths in the embodiment 2 in accordance with the present invention;

FIG. 19 is a table showing the relationship of FIGS. 19A and 19B;

FIG. 19A is a table showing the relationships between the substantially functioning input/output ports of the AWG and the output wavelengths in the embodiment 3 in accordance with the present invention;

FIG. 19B is a table showing the relationships between the substantially functioning input/output ports of the AWG and the output wavelengths in the embodiment 3 in accordance with the present invention;

FIG. 20 is a table showing the relationship of FIGS. 20A and 20B;

FIG. 20A is a table showing first relationships between the substantially functioning input/output ports of the AWG and the output wavelengths in the embodiment 4 in accordance with the present invention;

FIG. 20B is a table showing first relationships between the substantially functioning input/output ports of the AWG and the output wavelengths in the embodiment 4 in accordance with the present invention; and

FIG. 21 is a table showing the relationship of FIGS. 21A and 21B;

FIG. 21A is a table showing second relationships between the substantially functioning input/output ports of the AWG and the output wavelengths in the embodiment 4 in accordance with the present invention;

FIG. 21B is a table showing second relationships between the substantially functioning input/output ports of the AWG and the output wavelengths in the embodiment 4 in accordance with the present invention.

### DESCRIPTION OF THE EMBODIMENTS

The embodiments in accordance with the present invention will now be described in detail with reference to the accompanying drawings.

### Embodiment 1

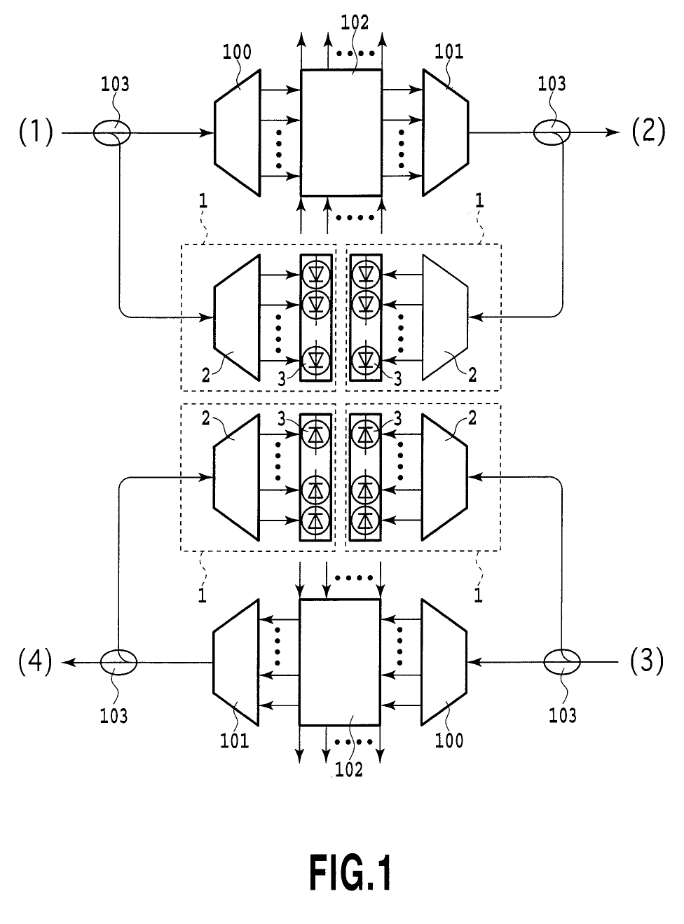

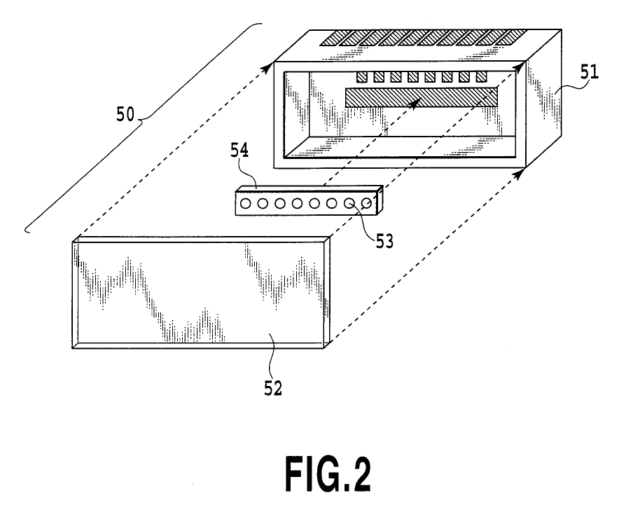

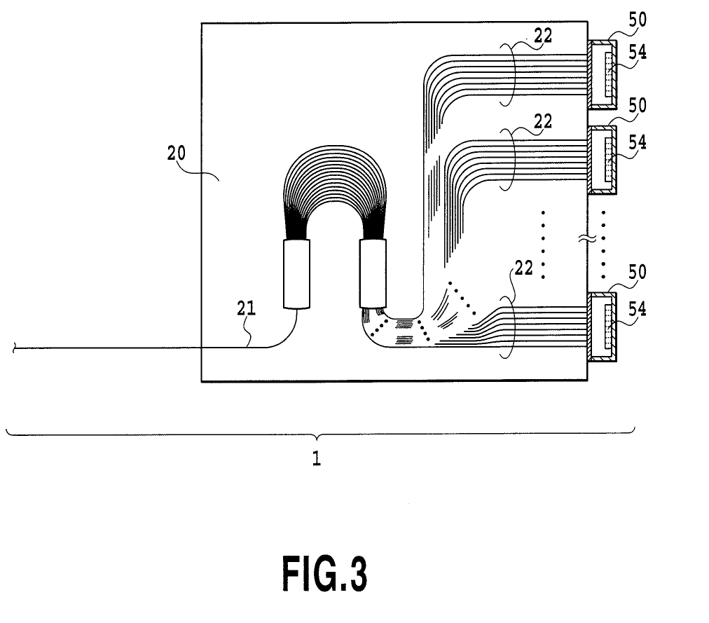

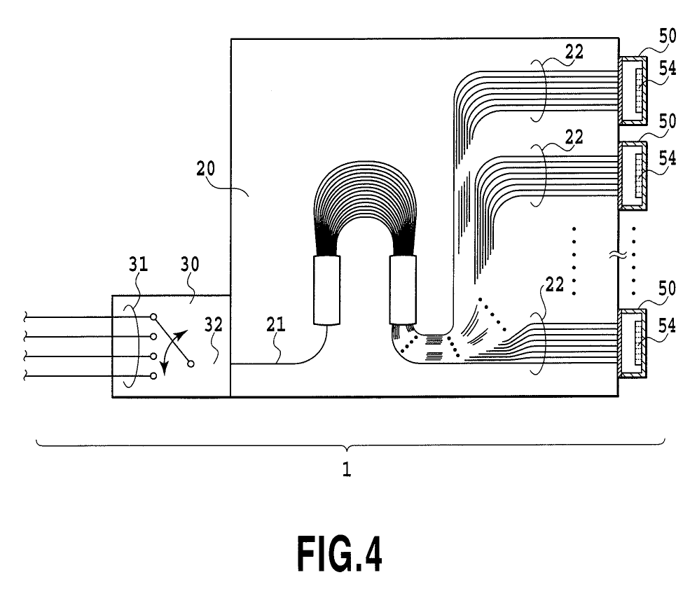

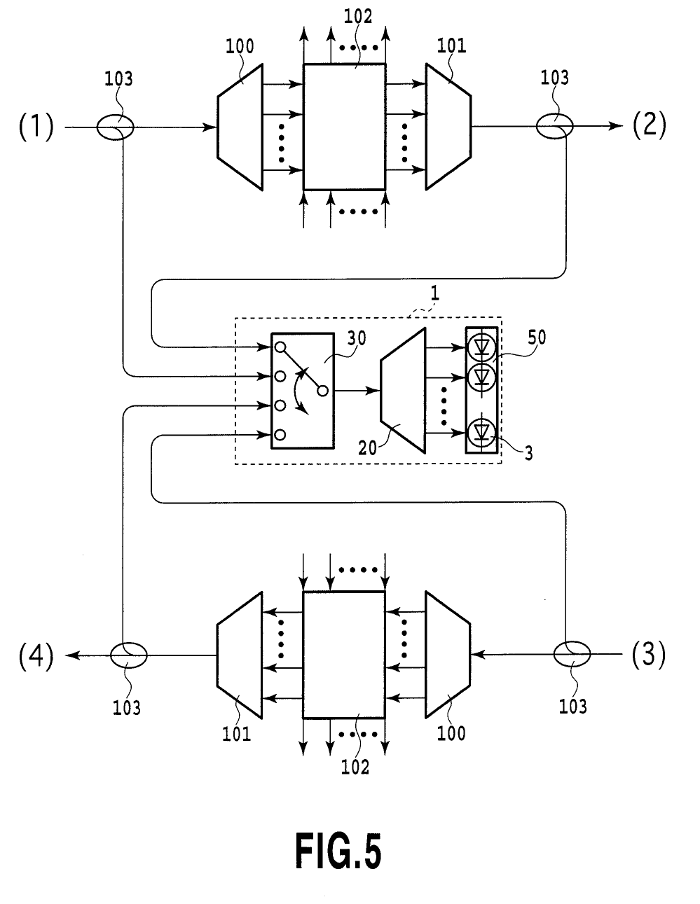

FIG. 4 shows a configuration of the optical power monitor of an embodiment 1 in accordance with the present invention. Here, the following description will be made by way of example of the optical power monitor used for an ROADM system with 48 wavelength channels. In addition, as the monitoring positions of a WDM signal, let us take an example that monitors the power of the optical signal of each wavelength channel at the inlet ((1) or (3) in FIG. 1) or outlet ((2) or (4) in FIG. 1) of the node as shown in FIG. 5. More specifically, an example that monitors at four positions will be described here. The portion enclosed by broken lines in FIG. 5 corresponds to the optical power monitor 1 shown in FIG. 4.

The optical power monitor 1 of the present embodiment shown in FIG. 4 comprises an optical switch 30 having four input ports 31, an AWG 20 with 48 output ports, and six CSP type PD array modules 50 each including an 8-channel PD array. Here, the optical switch 30 and the AWG 20, which are implemented in the form of a planar lightwave circuit (PLC), are employed as the optical switch 30 and the DMUX 20.

The optical switch 30 with the four switchable input ports 31 has its output port 32 connected to the input port 21 of the AWG 20 via optical coupling. In addition, the 48 output ports 22 of the AWG 20 are optically connected to the photosensitive surfaces 53 of PDs included in the CSP type PD array modules 50 which are mounted on the end face of the AWG 20, respectively. The four input ports 31 of the optical switch 30 are optically connected to couplers 103 that split the WDM signals fed from (1) and (3) in FIG. 5 and the WDM signals output to (2) and (4) in FIG. 5, respectively.

A method of monitoring each of the WDM signals will be described below. For example, assume that the optical power of each wavelength channel of the WDM signal flowing through (1) of FIG. 5 is to be monitored. In this case, the optical switch is operated in such a manner that among the four input ports 31 of the optical switch 30, the input port 31 to which the WDM signal is supplied from (1) of FIG. 5 is connected to the output port 32. Thus, the WDM signal from (1) of FIG. 5 is supplied to the AWG 20. The WDM signal is demultiplexed to the individual wavelengths by the AWG 20, and the individual optical signals are received by the PDs 3 so that the optical power of the individual light wavelength signals of the WDM signal fed from (1) of FIG. 5 can be monitored.

Next, the optical switch 30 is operated in such a manner that among the four input ports 31 of the optical switch 30, the input port 31 to which the WDM signal output from (2) of FIG. 5 is supplied is connected to the output port 32. Thus, the optical power of the individual wavelength channels of the WDM signal flowing through (2) of FIG. 5 can be monitored. Likewise, the optical switch 30 is sequentially operated in such a manner that the input port 31 to which the WDM signal output from (3) of FIG. 5 of the optical switch is supplied is connected to the output port 32, and that the input port 31 to which the WDM signal output from (4) of FIG. 5 of the optical switch is supplied is connected to the output port 32. Thus, the optical powers of the individual light wavelength signals of the WDM signal at the four monitoring positions can be monitored.

As to the order of monitoring the optical power at the four positions, it is not necessary to carry out in order. More specifically, the order of monitoring the optical power depends on the monitoring algorithm of the WDM system. Accordingly, random monitoring is also possible, or monitoring of the light wavelength signal at a particular position is also possible by freely operating the optical switch 30.

As described above, the optical power monitors, which must be placed at four positions as shown in FIG. 1 conventionally, can be reduced to only one position by introducing the optical switch 30 as shown in FIGS. 4 and 5 according to the present embodiment. In addition, since the conventional optical power monitors are placed at the four positions, the numbers of the components required are: four AWGs 20; and 24 CSP type PD array modules 50 each including the 8-channel PD array. In contrast with this, the present embodiment requires only one AWG 20, and six CSP type PD array modules 50 each including the 8-channel PD array, thus being able to reduce the number of the major components to a quarter. In practice, since the number of the electronic components such as logarithmic amplifiers mounted after the PDs can be reduced accordingly, it is possible to greatly reduce not only the components, but also the assembling cost.

Although the present embodiment is described by way of example of optically connecting the optical switch 30, the AWG 20 and the CSP type PD module 50 directly, they can be connected optically via optical fibers or the like, and the connecting manner is not limited at all. The present embodiment is only described by way of example that can minimize the numbers of components by directly connecting them, that is, in the manner that will enable the miniaturization and cost reduction.

Furthermore, the optical switch 30 is not limited to the optical switch based on the PLC. For example, it may be an optical fiber type, a bubble type, or a MEMS (Micro Electro Mechanical Systems) type, and thus the type of the optical switch is not limited. In the present embodiment, the configuration is simply described which enables multichannel, miniaturization, and cost reduction with high reliability easily by using the optical switch based on the PLC, which has already attained sufficient marketplace achievements.

As for the DMUX, it is not limited to the AWG 20 based on the PLC. For example, a dielectric multilayer or a bulk grating can also be employed, and the configuration of the DMUX is not limited at all. In the present embodiment, the configuration is simply described which enables multichannel, miniaturization, and cost reduction with high reliability easily by using the AWG 20 as the DMUX.

As for the multichannel PD construction, it is not limited to the construction described in the present embodiment, which has six CSP type PD array modules 50 each including 8-channel PD array. For example, it is possible to use 48 single-channel CAN PD modules, or two 24-channel PD arrays. In other words, it is enough to prepare the PDs 3 by the number of the output ports 22 of the DMUX. In the present embodiment, the case is simply described which has six CSP type PD array modules 50 each including 8-channel PD array, which will enable the miniaturization in particular.

As for the number of the input ports 31 of the optical switch 30, it is not limited to four of the present embodiment. The number of the input ports 31 of the optical switch 30 depends on the number of the WDM signals to be monitored in the apparatus. Thus, assume that the number of the monitors required is n, the number of the input ports 31 of the optical switch 30 is equal to or greater than n. As a result, the present embodiment can reduce the number of the DMUX and the number of the PDs used for the optical power monitor to 1/n as those of the conventional apparatus. In addition, it can reduce the number of the post stage electronic components in proportions to them. Accordingly, the present embodiment can reduce the assembling cost with reducing the space the optical power monitor occupies, and can achieve the substantial miniaturization and cost reduction.

### Embodiment 2

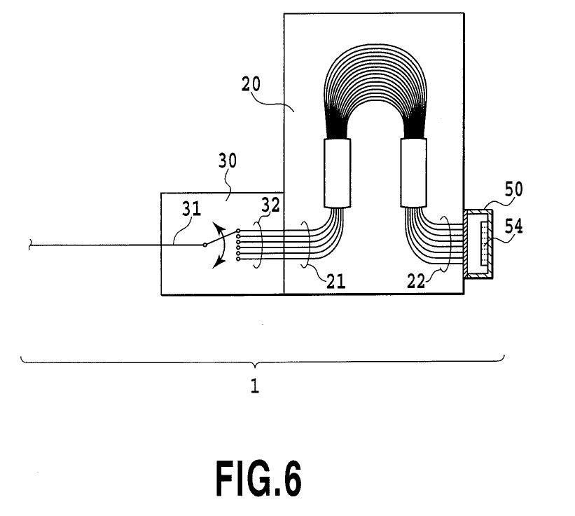

FIG. 6 shows a configuration of the optical power monitor of an embodiment 2 in accordance with the present invention. Here, the description will be made byway of example of the optical power monitor used for an ROADM system with 48 wavelength channels. The optical power monitor 1 has an optical switch 30 having six output ports 32 implemented by a PLC, an AWG 20 having six input ports 21 and eight output ports 22, which are also implemented by the PLC, and a CSP type PD array module 50 including an 8-channel PD array 54.

The six output ports 32 of the optical switch 30 are optically coupled to the six input ports 21 of the AWG 20, respectively. In addition, the eight output ports 22 of the AWG 20 are optically connected to the photosensitive surfaces 53 of the eight PDs included in the CSP type PD array module 50, respectively. Thus, the CSP type PD array module 50 is mounted on the end faces of the output waveguides 22 of the AWG 20.

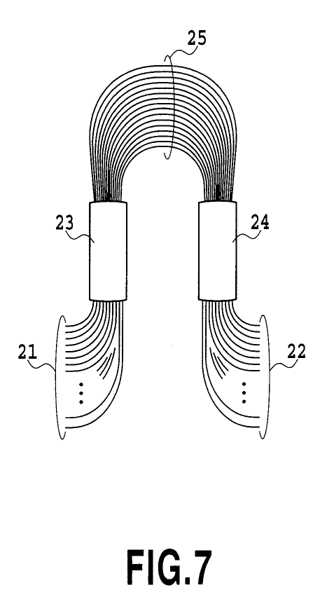

Generally, an AWG having M input ports and M output ports can multiplex or demultiplex M light wavelength signals. As shown in FIG. 7, the AWG 20 comprise M input waveguide 21 and M output waveguide 22, a first slab waveguide 23 and a second slab waveguide 24, and arrayed waveguides 25 which differ in length at a constant ratio. When the WDM signal is input to the input ports 21 of the AWG 20, the light wavelength signals demultiplexed into individual wavelengths can be output from the output ports 22.

If the position of the port to which the WDM signal is input is shifted by m ports from the original position, for example, the individual light wavelength signals, which are demultiplexed through the AWG and emitted from the output ports, are output from the output ports shifted by m ports from the original output ports.

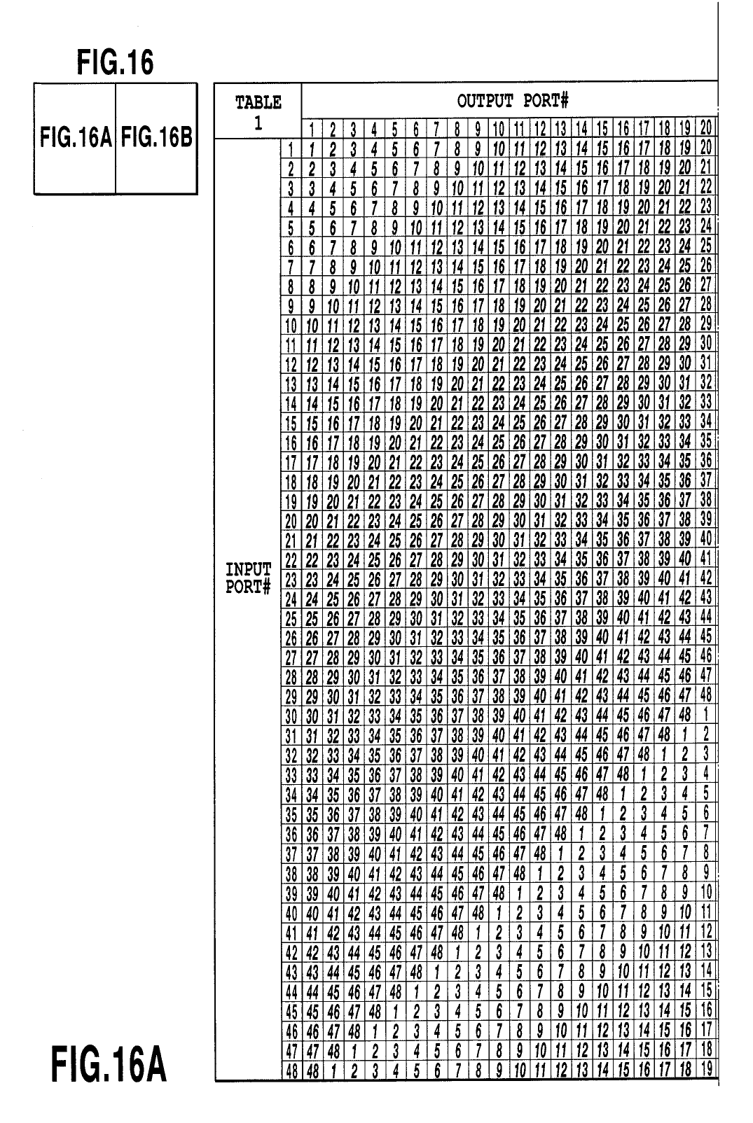

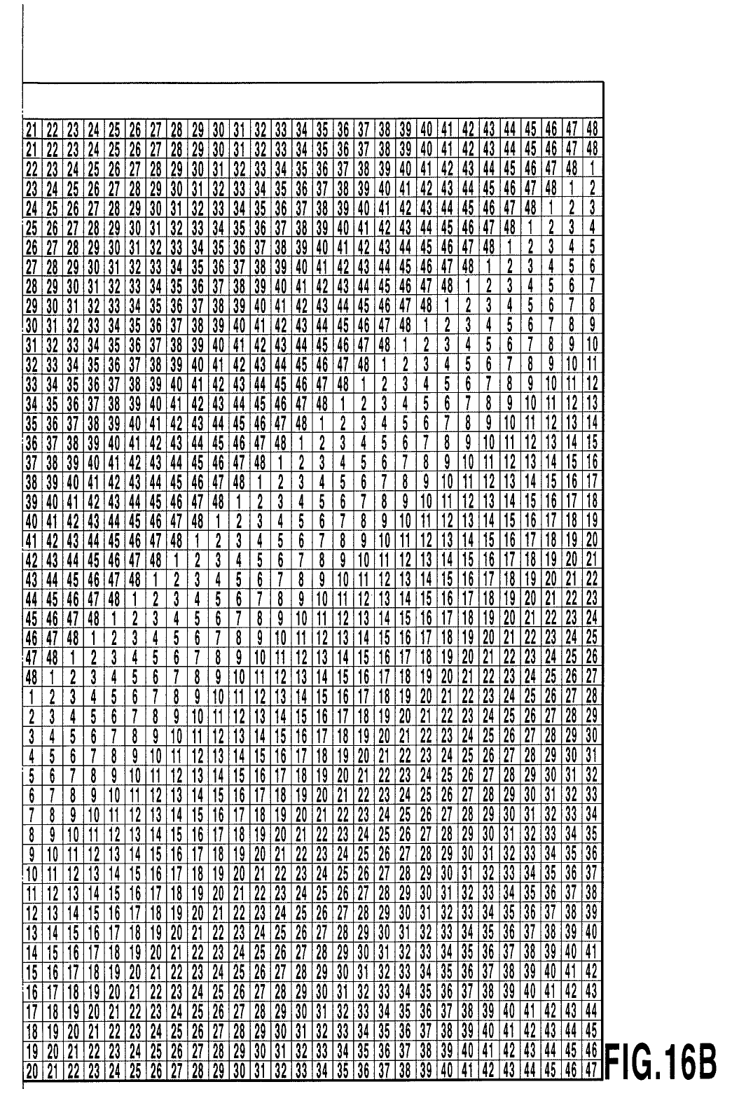

Table 1 of FIGS. 16A and 16B shows the correspondence between the input and output wavelengths in an example of the AWG with 48 inputs and 48 outputs. Each column shows the numbers # of the input ports, and each row shows the numbers # of the output ports. In addition, italic numbers in the Table 1 of FIGS. 16A and 16B are wavelength numbers λ of the light wavelength signals emitted from output ports among the WDM signal input to the input ports. For example, assume that the input port #25 is supplied with the WDM signal obtained by multiplexing the light wavelength signals from the wavelength number λ1 to λ48. Then, the optical signals with the individual wavelengths are demultiplexed and extracted from the output ports #1 to #48. Subsequently, assume that the input port #29, the input port shifted by four ports, is supplied with the WDM signal obtained by multiplexing the light wavelength signals from the wavelength number λ1 to λ48. Then, it is found that the optical signals with the individual wavelengths which are demultiplexed and output are emitted from the output ports shifted by four ports from the original ports. The embodiment 2 offers the following advantages by applying the operation of the AWG.

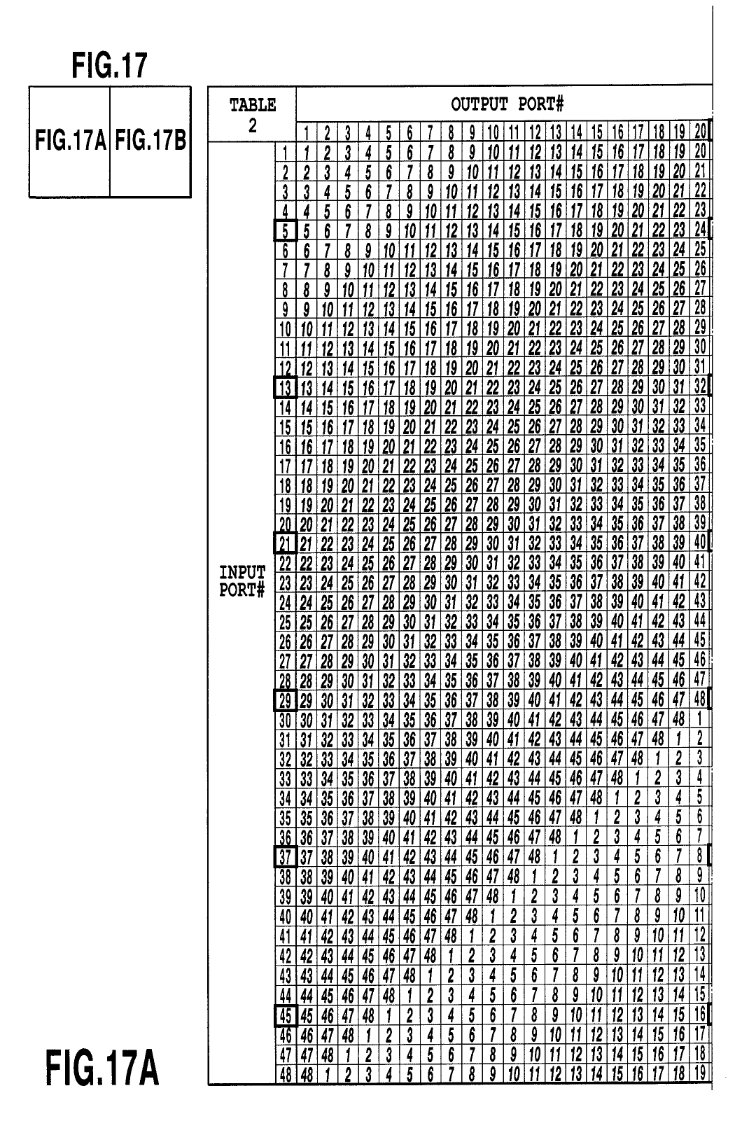

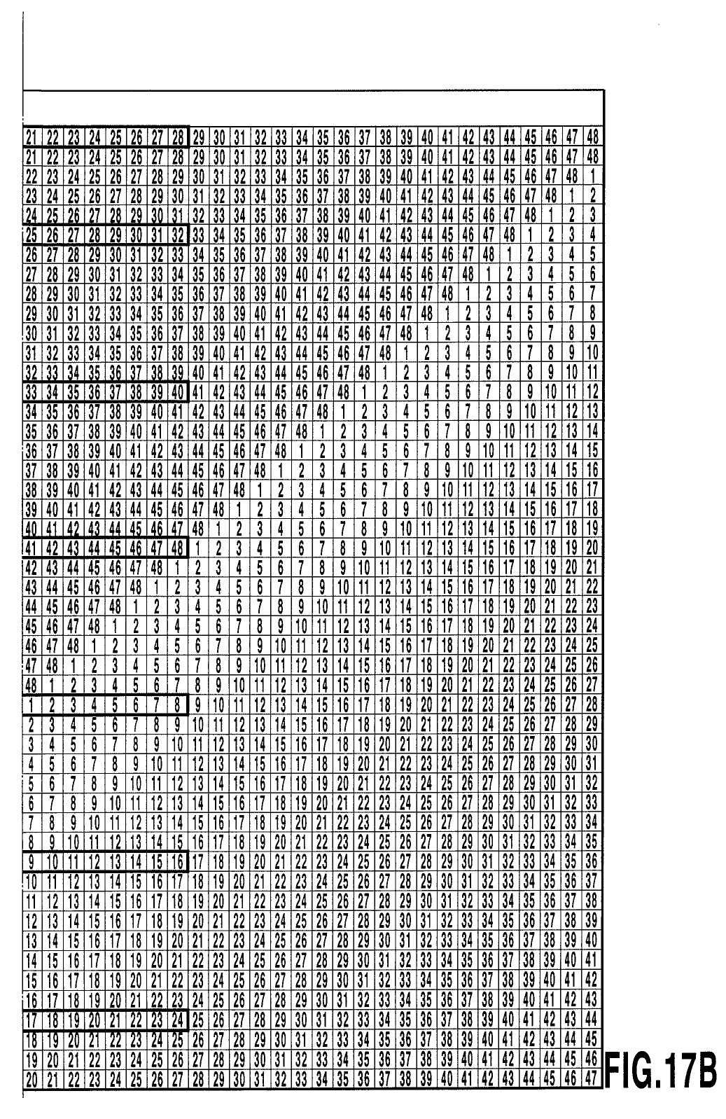

In the AWG 20 designed to have the input of 48 channels and the output of 48 channels, as shown in Table 2 of FIGS. 17A and 17B, for example, as to the six input waveguides 21 at the input ports #5, #13, #21, #29, #37, and #45 placed at every eight port interval, the consecutive eight output waveguides 22 at the output ports #21, #22, #23, #24, #25, #26, #27, and #28 are optically connected to the PDs. Here, the CSP type PD array module 50 including the 8-channel PD array 54 is mounted on the end faces of the output waveguides 22 of the AWG 20. On the other hand, the optical switch 30 has six output ports 32 that are optically connected to the six input ports 21 of the AWG 20, respectively. Thus, at the input port side of the AWG 20, the substantially functioning input ports are placed at prescribed intervals, and at the output port side, the substantially functioning output ports are placed consecutively. The meaning of the term “substantially functioning” will be described later.

Next, a method of monitoring the WDM signal input to the optical switch 30 will be described. For example, consider the case of monitoring the optical power of the light wavelength signals λ25 to λ32 each. In this case, it is enough to operate the optical switch 30 in such a manner that the output port 32 of the optical switch 30 connected to the input port #5 of the AWG 20 is reached. Then, in the WDM signal which is input to the AWG 20 and is demultiplexed, the light wavelength signals λ25 to λ32 are emitted from the output ports #21 to #28 of the AWG 20. After that, the light wavelength signals λ25 to λ32 are received by the PDs 3, respectively. Next, when the optical switch 30 is operated in such a manner that the output port 32 of the optical switch 30 connected to the input port #13 of the AWG 20 is reached, the optical signals with the wavelength numbers λ33 to λ40 among the light wavelength signals are emitted from the output ports #21 to #28 of the AWG this time. They are also received by the PDs 3, respectively. Likewise, by operating the optical switch 30, all the optical powers of the wavelength channels of the WDM signals can be monitored at every 8-wavelength interval.

As to the order of monitoring the optical power, it is not necessary to carry out in order, but it depends on the monitoring algorithm of the WDM system. Accordingly, random monitoring is also possible, or monitoring of a particular light wavelength signal is also possible by freely operating the optical switch.

As described above, although the conventional optical power monitor must place the PDs by the number of the wavelength signals to be monitored, the present embodiment can reduce the number of the PDs to be placed by introducing the optical switch 30 before the AWG 20. For example, although the conventional 48-channel optical power monitor requires 48 PDs, the present embodiment, which introduces the optical switch 30 having six output ports 32 before the AWG 20, can reduce the number of PDs to eight or ⅙.

Generally, in the optical power monitor that handles the WDM signal including M wavelengths, the number of the output ports of the optical switch is M/L, where L is the number of the PDs used (L<M is assumed here). Thus, as for the substantially functioning input/output ports of the AWG, the number of the input ports is M/L, and the number of the output ports is L. As a result, compared with the conventional technology, the reduction effect of the PDs is L/M. Since M and L are integers, if M is not divisible by L, it is possible to deal with this by setting the number of the output ports of the optical switch and the number of the input ports of the AWG at (the quotient of M/L)+1 or the like.

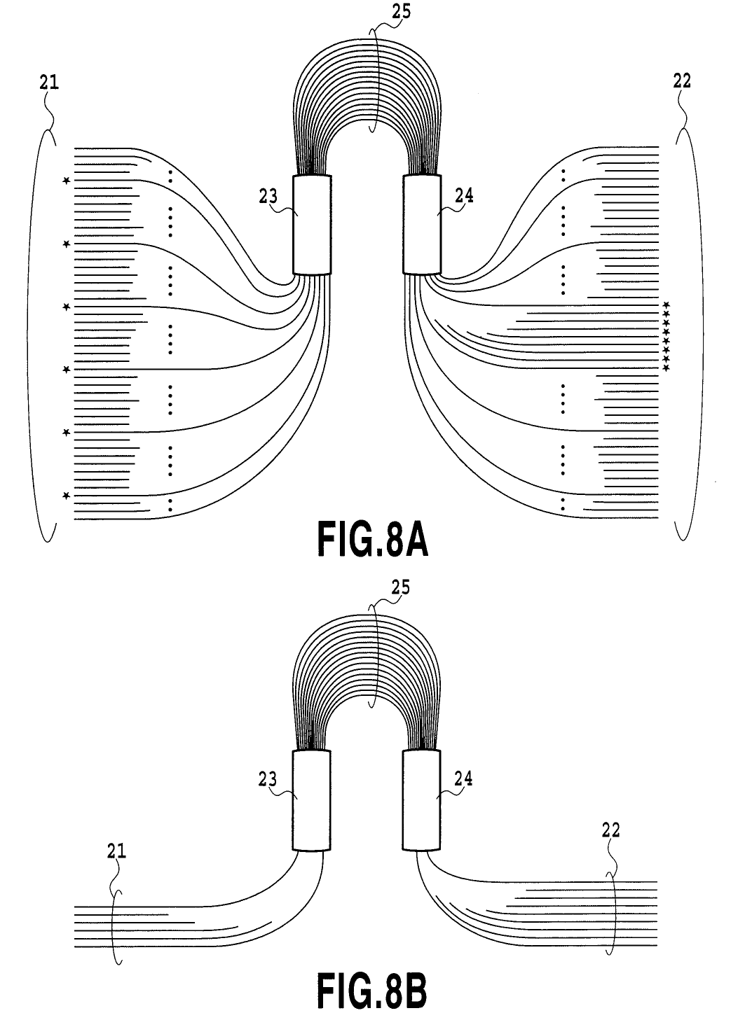

Incidentally, the expression “substantially functioning” input ports (waveguides) or output ports (waveguides) of the AWG has the following meaning. For example, as shown in FIG. 8A, according to the design of the AWG 20, the number of the input ports 21 is 48, and the number of the output ports 22 is also 48. However, the number of the input ports 21 on the AWG 20 side, which are connected with the output ports 32 of the optical switch 30 at the preceding stage, is six input ports (waveguides) placed at every 8 port interval as shown in Table 2 of FIGS. 17A and 17B (the input ports 21 designated by an asterisk in FIG. 8A). In other words, since the remaining input ports (waveguides) are not used, the input ports (waveguides) other than the substantially functioning input ports (waveguides) need not be placed in practice as shown in FIG. 8B. Thus, the input ports 21 of the AWG 20 connected to the output ports 32 of the optical switch 30 is specifically expressed as the “substantially functioning” input ports (waveguides). In this case, however, the positions at which the substantially functioning input waveguides 21 are connected to the first slab waveguide 23 are not changed. On the other hand, on the output port (waveguide) side of the AWG 20, only the output ports connected to the PDs 3 function substantially according to the present invention. Thus, the expression “substantially functioning” output ports (waveguides) are used for the output ports connected to the PDs 3. In this case also, the positions at which the substantially functioning output waveguides 22 are connected to the second slab waveguide 24 are not changed. The ports designated by an asterisk in FIG. 8A are the substantially functioning input ports (waveguides) and output ports (waveguides), which correspond to the port numbers enclosed by thick blocks in Table 2 of FIGS. 17A and 17B. Accordingly, the AWG 20 is composed in practice of only the substantially functioning input ports (waveguides) and output ports (waveguides) excluding the input ports (waveguides) and output ports (waveguides) which are not designated by an asterisk as shown in FIG. 8B.

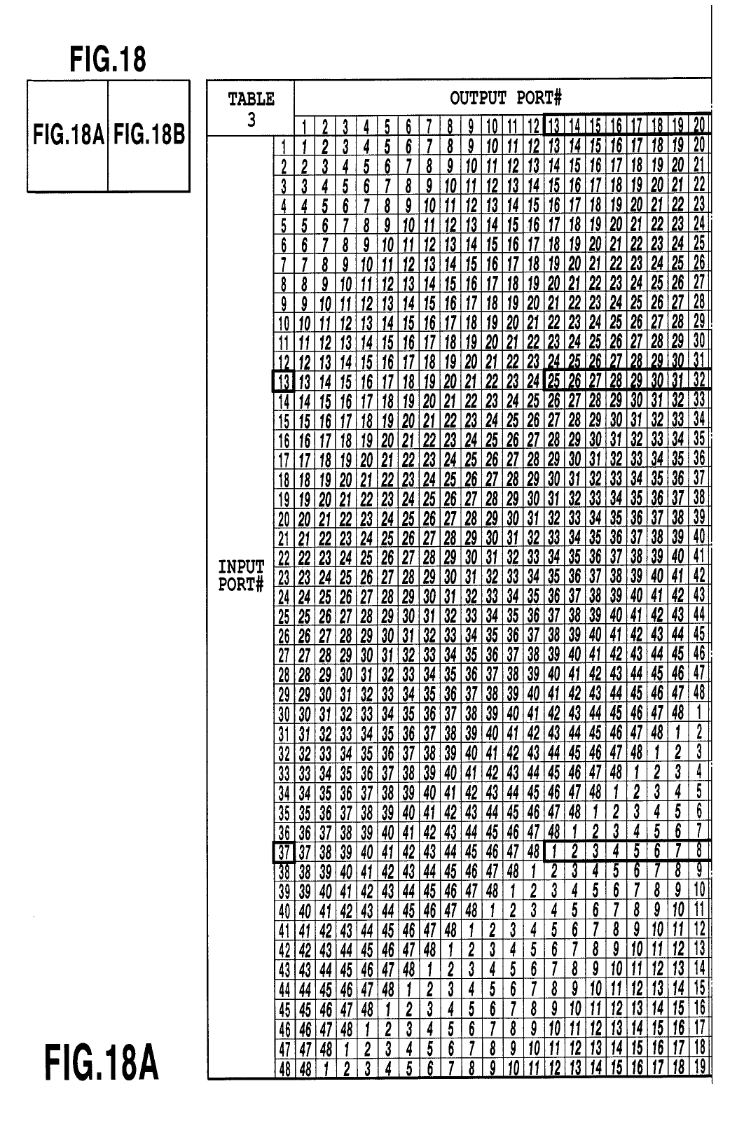

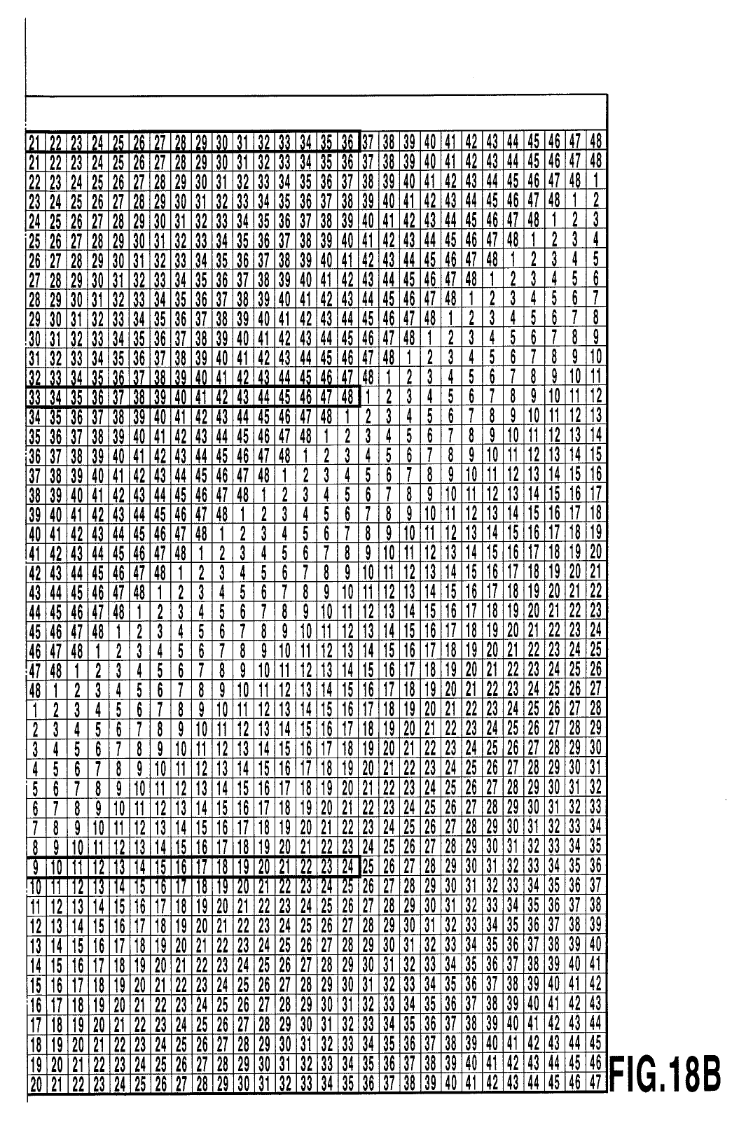

As for the number of the output ports 32 of the optical switch 30 and the number of the substantial input ports 21 of the AWG 20, they are not limited to six of the present embodiment. Since these numbers are a design item of the optical power monitor, they can be changed freely. For example, if 24-channel PDs are employed as shown in Table 3 of FIGS. 18A and 18B, the number of the output ports 32 of the optical switch 30 and the number of the substantially functioning input ports 21 of the AWG 20 is two and so on.

As described above, although the conventional optical power monitor must place the PDs by the number of the wavelengths to be monitored, the present embodiment can reduce the number of the PDs by introducing the optical switch 30 having a plurality of output ports 32 before the AWG 20. In addition, since the number of the electronic components such as logarithmic amplifiers implemented after the PDs can be reduced accordingly, it is possible to greatly reduce not only the components of the optical power monitor, but also the assembling cost. Furthermore, the reduction in the number of the PDs to be connected to the AWG 20 enables the reduction in space occupied by the waveguide layout that is necessary for connecting the output waveguides 22 of the AWG 20 to the individual PDs. Thus, the chip size itself of the AWG 20 can be miniaturized.

Although the present embodiment is described by way of example of optically connecting the optical switch 30, the AWG 20 and the CSP type PD module 50 directly, they can be connected optically via optical fibers or the like, and the connecting manner is not limited at all. The present embodiment is only described by way of example that can minimize the numbers of components by directly connecting them, that is, in the manner that will enable the miniaturization and cost reduction.

Furthermore, the optical switch 30 is not limited to the optical switch based on the PLC. For example, it may be an optical fiber type, a bubble type, or a MEMS (Micro Electro Mechanical Systems) type, or if high speed switching is necessary, a very high-speed switch such as an LN or EA is applicable. Thus, the type of the optical switch is not limited. In the present embodiment, the configuration is simply described which enables multichannel, miniaturization, and cost reduction with high reliability easily by using the optical switch based on the PLC, which has already attained sufficient marketplace achievements.

As for the multichannel PD construction, it is not limited to the construction described in the present embodiment, which has the CSP type PD array module 50 including 8-channel PD array. For example, it is possible to use eight single-channel CAN PD modules, or two CSP type PD array modules each including 4-channel PD array. In the present embodiment, the example having the single CSP type PD array module 50 including the 8-channel PD array 54 is simply described, because it will enable the miniaturization in particular.

### Embodiment 3

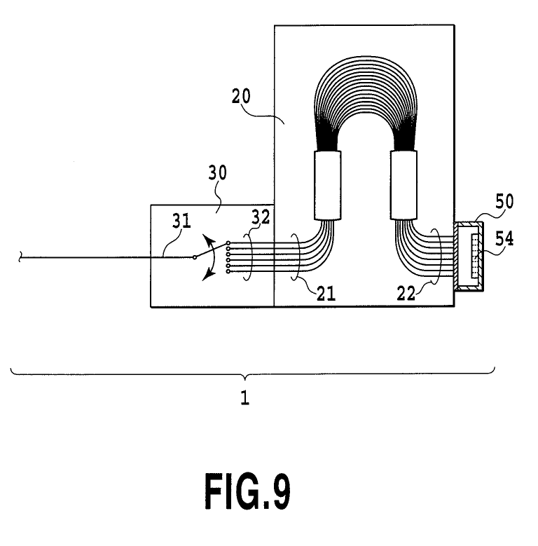

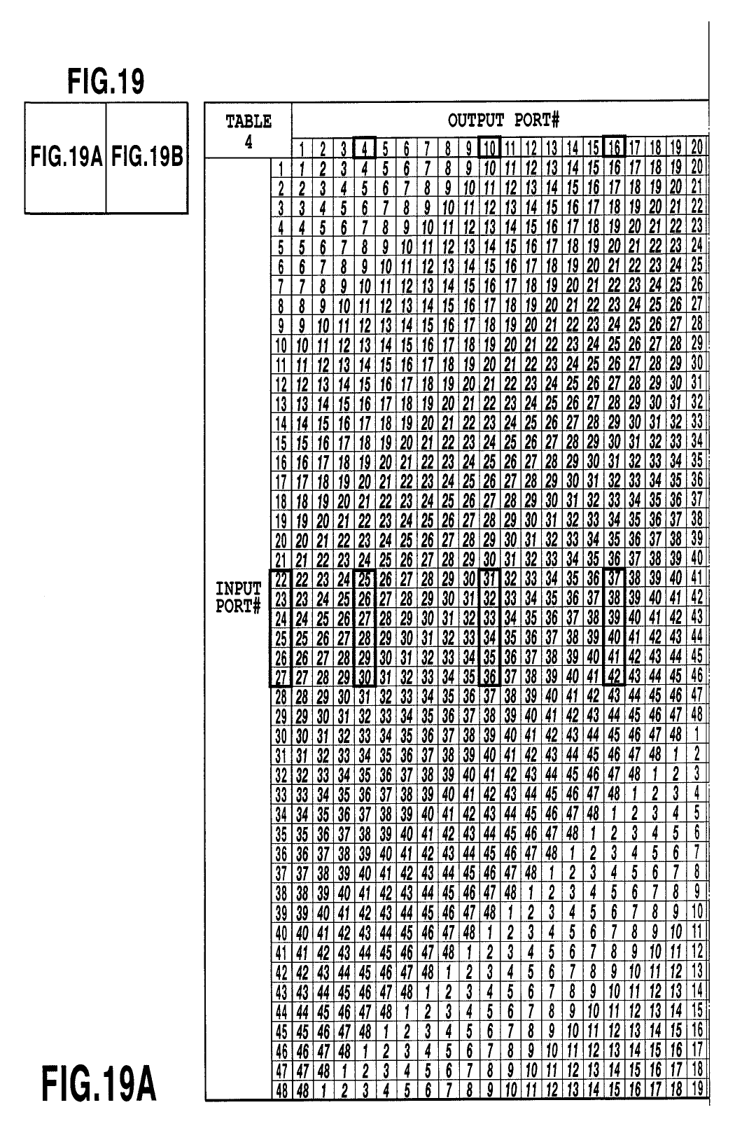

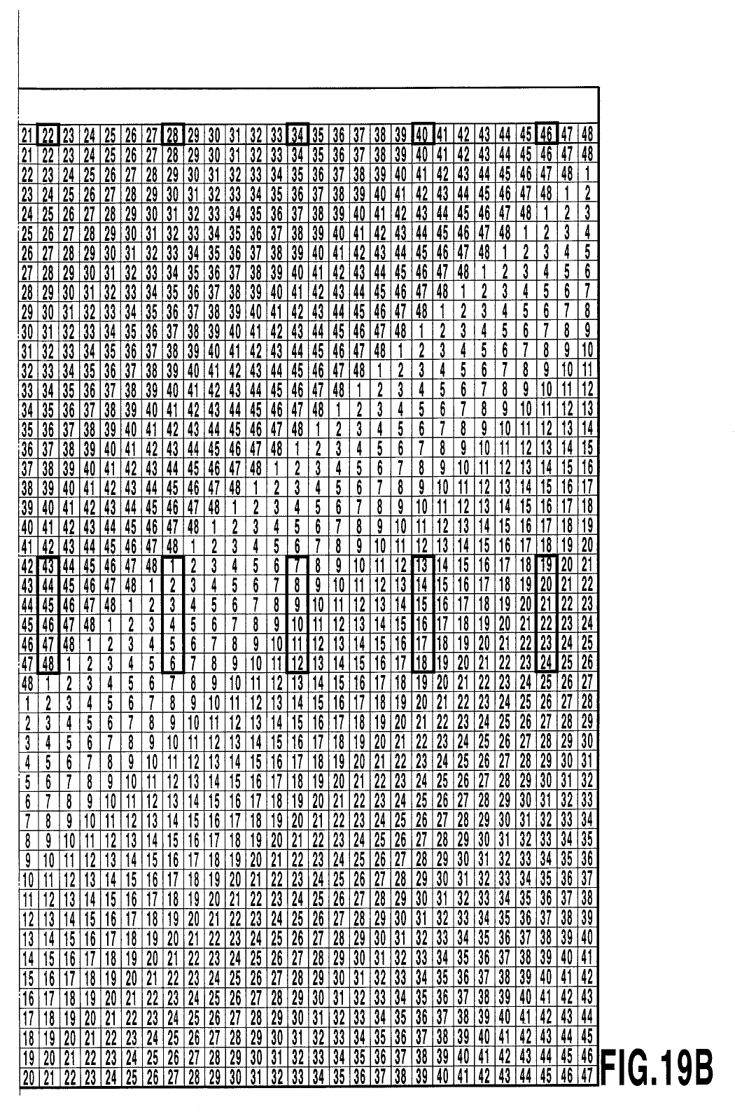

FIG. 9 shows a configuration of the optical power monitor of an embodiment 3 in accordance with the present invention. In addition, Table 4 of FIGS. 19A and 19B shows an arrangement example of the substantially functioning input/output ports of the AWG 20. Here, the description will be made by way of example of the optical power monitor used for an ROADM system with 48 wavelength channels, as well as embodiment 2.

The present embodiment differs from the embodiment 2 in the following. More specifically, in the AWG 20 designed to possess 48 input channels and 48 output channels, as to the consecutive six input waveguides such as the input ports #22, #23, #24, #25, #26, and #27 as shown in Table 4 of FIGS. 19A and 19B, for example, eight output waveguides 22 consisting of the output ports #4, #10, #16, #22, #28, #34, #40, and #46 placed at every six port interval are optically connected to the PDs, respectively. More specifically, the present embodiment differs from the embodiment 2 in that it employs, on the input port side of the AWG 20, the adjacent consecutive input ports as the substantially functioning input ports 21, and on the output port side, the output ports placed at every interval of a prescribed number of ports as the substantially functioning output ports 22.

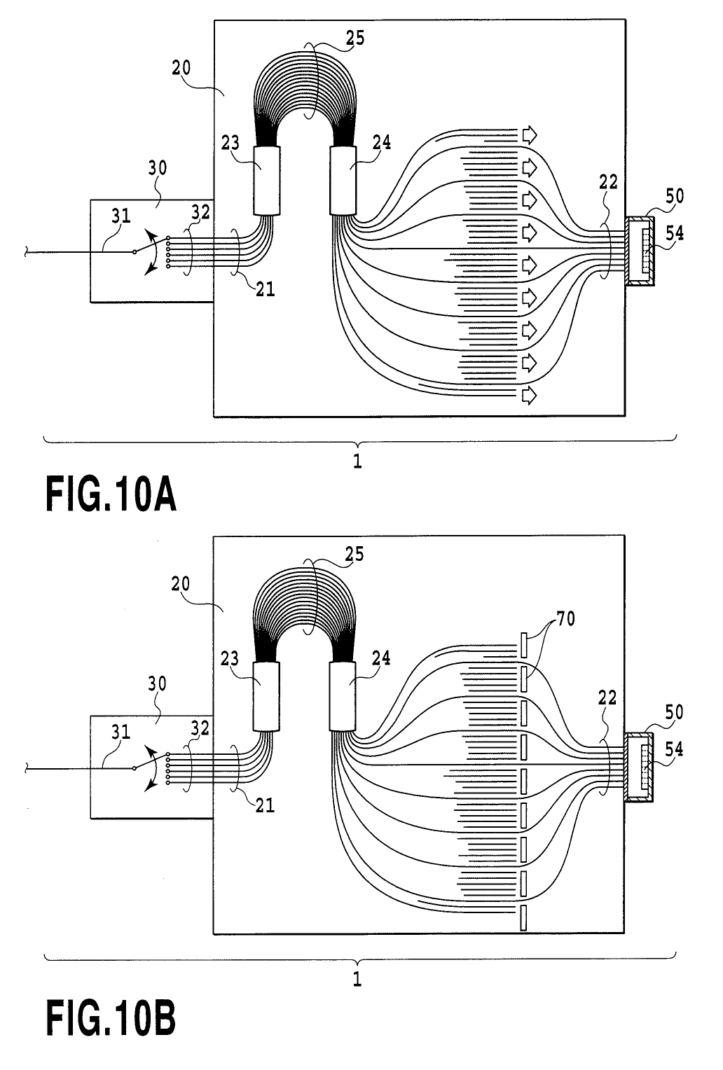

Since FIG. 9 shows only the substantially functioning input ports (waveguides) and output ports (waveguides), it is difficult to distinguish the present embodiment from the embodiment 2. Thus, FIG. 10A shows the configuration including non-substantially functioning output waveguides. FIG. 10A, however, is a diagram only for explanation, and it is not necessary for the actually fabricated AWG 20 to have the output waveguides other than the substantially functioning output waveguides as shown in FIG. 9.

Next, a method of monitoring the WDM signal input to the optical switch 30 will be described. For example, consider the case of monitoring the optical powers of λ25, λ31, λ37, λ43, λ1, λ7, λ13 and λ19 in the light wavelength signals. In this case, it is enough to operate the optical switch 30 in such a manner that the output port 32 of the optical switch 30 connected to the input port #22 of the AWG 20 is reached. Then, in the WDM signal which is input to the AWG 20 and is demultiplexed, the light wavelength signals λ25, λ31, λ37, λ43, λ1, λ7, λ13, and λ19 are emitted from the output ports #4, #10, #16, #22, #28, #34, #40, and #46 of the AWG 20, respectively. After that, the light wavelength signals λ25, λ31, λ37, λ43, λ1, λ7, λ13, and λ19 are received by the PDs 3, respectively. Next, when the optical switch 30 is operated in such a manner that the output port 32 of the optical switch 30 connected to the input port #23 of the AWG 20 is reached, the optical signals λ26, λ32, λ38, λ44, λ2, λ8, λ14, and λ20 among the light wavelength signals are emitted from the output ports #4, #10, #16, #22, #28, #34, #40, and #46 of the AWG 20, respectively, this time. They are also received by the PDs 3, respectively. Likewise, by operating the optical switch 30, all the optical powers of the wavelength channels of the WDM signals can be monitored at every 8-wavelength interval.

The present embodiment offers, in addition to the advantages of the embodiment 2, an advantage of being able to improve adjacent cross talk decided by the characteristics of the AWG. More specifically, in the embodiment 2, since the substantially functioning output ports (waveguides) 22 of the AWG are consecutive, the signal light of the individual wavelengths received by the PDs is highly susceptible to the effect of the adjacent cross talk of the AWG 20. In contrast, according to the present embodiment, each wavelength signal light received by the PD is a light wavelength signal extracted from one of the substantially functioning output ports (waveguides) 22 of the AWG 20, which are placed at prescribed intervals. Accordingly, the cross talk is low nearly at the level of the background. As a result, the cross talk can be reduced greatly.

To make the cross talk reduction effect more conspicuous in the present embodiment, it is preferable to take the following measure. As shown in FIG. 10A, on the output port side, the non-substantially functioning output waveguides drawn out of the end face of the second slab waveguide 24 (or even if these output waveguides do not exist) emit the demultiplexed light wavelength signals. Accordingly, as indicated by arrows in FIG. 10A, the spurious optical signals strike on regions different from the photosensitive surfaces of the PDs. The spurious optical signals, which become stray light, can be absorbed into the PDs and cause cross talk, thereby constituting a factor of deteriorating the characteristics of the optical power module 1. In view of this, when mounting the PDs at the end of the output waveguides 22, it is preferable to take a shading measure 70 at the end faces of the non-substantially functioning output waveguides such as removing cladding or filling with a shading material as shown in FIG. 10B. Alternatively, it is preferable to place the PDs at positions where the photosensitive surfaces of the PDs deviate from the end faces of the non-substantially functioning output waveguides.

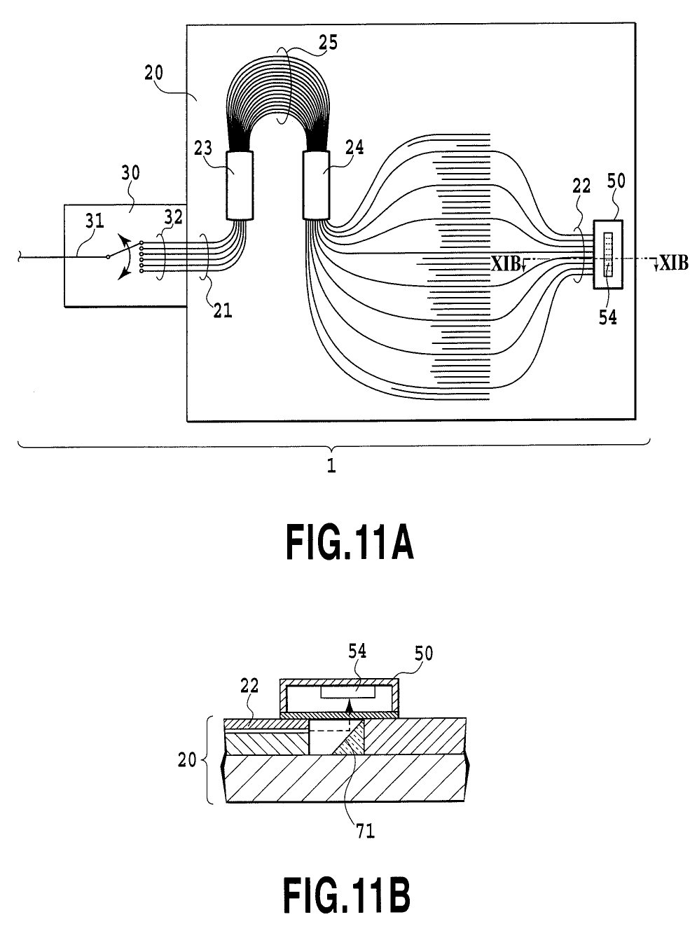

FIG. 11A shows a configuration of an embodiment capable of further reducing the cross talk, and FIG. 11B shows a cross section taken along the line XIB-XIB in FIG. 11A. An optical path changing mirror 71 is placed only on the way from the substantially functioning output waveguides 22, and the CSP type PD array module 50 is mounted on an upper part. Thus, the substantially functioning output waveguides 22 and the CSP type PD array module 50 are optically connected via the optical path changing mirror 71, and the reception of the spurious optical signals can be prevented.

In FIGS. 10(a) and 10(b) and FIG. 11A, to facilitate the understanding of the construction of the present embodiment, the chip size of the AWG 20 is enlarged in order to include the non-substantially functioning waveguides. However, since it is not necessary to fabricate the non-substantially functioning waveguides in practice, the present embodiment can also miniaturize the chip size as shown in FIG. 9. Even if the non-substantially functioning waveguides are not fabricated, the spurious optical signals leaks from the end face of the second slab waveguide, and thus it is preferable to take precautions to prevent the foregoing stray light.

### Embodiment 4

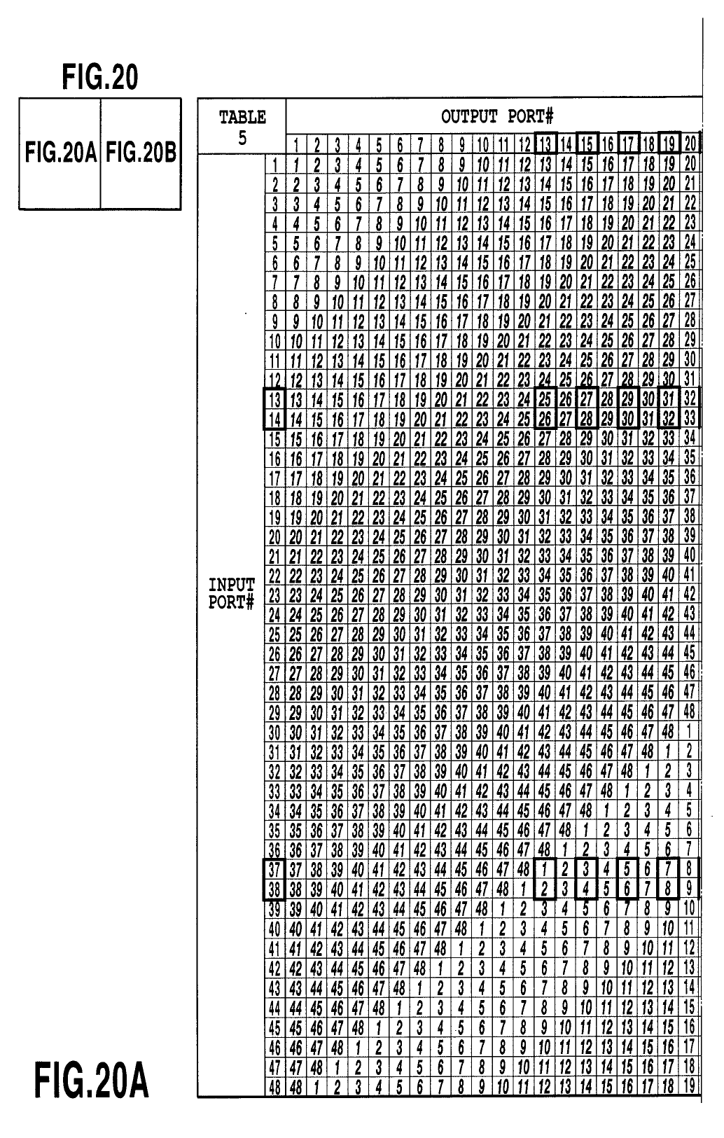

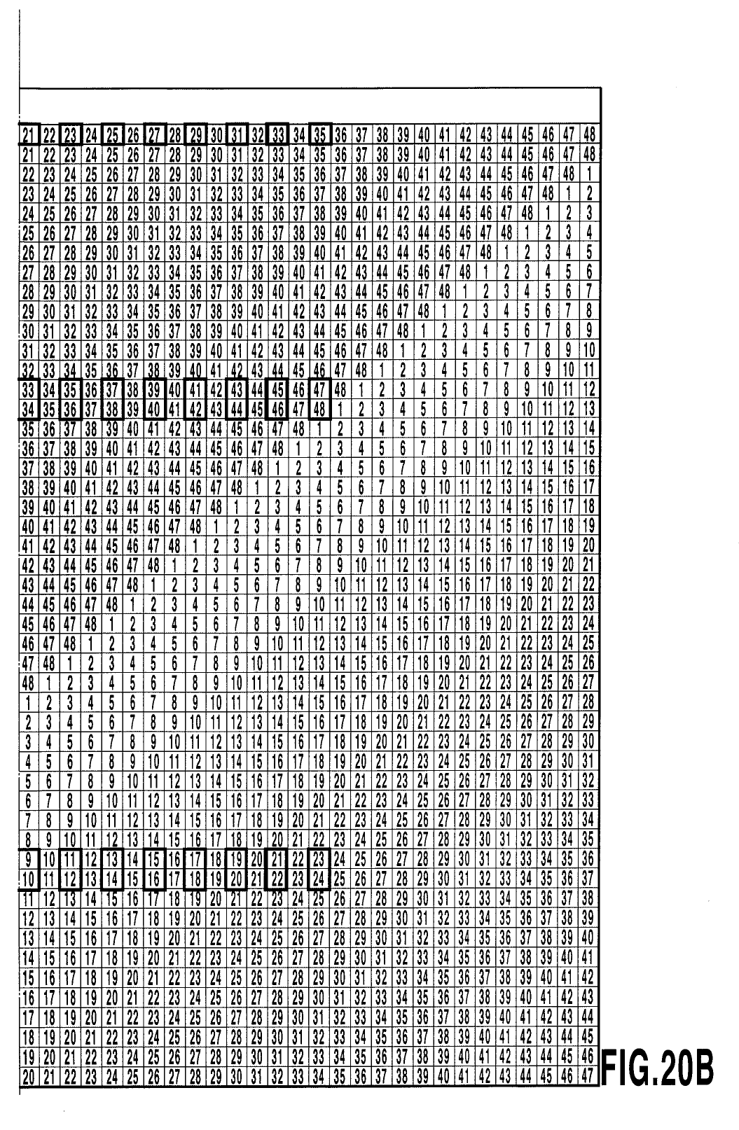

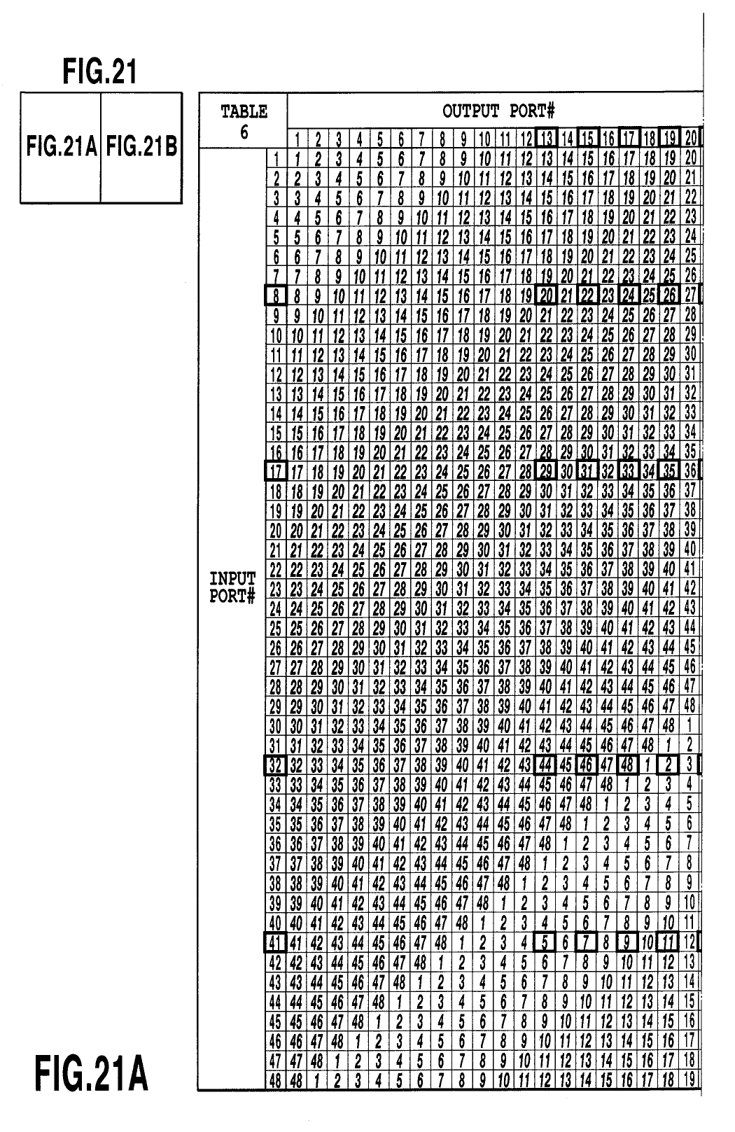

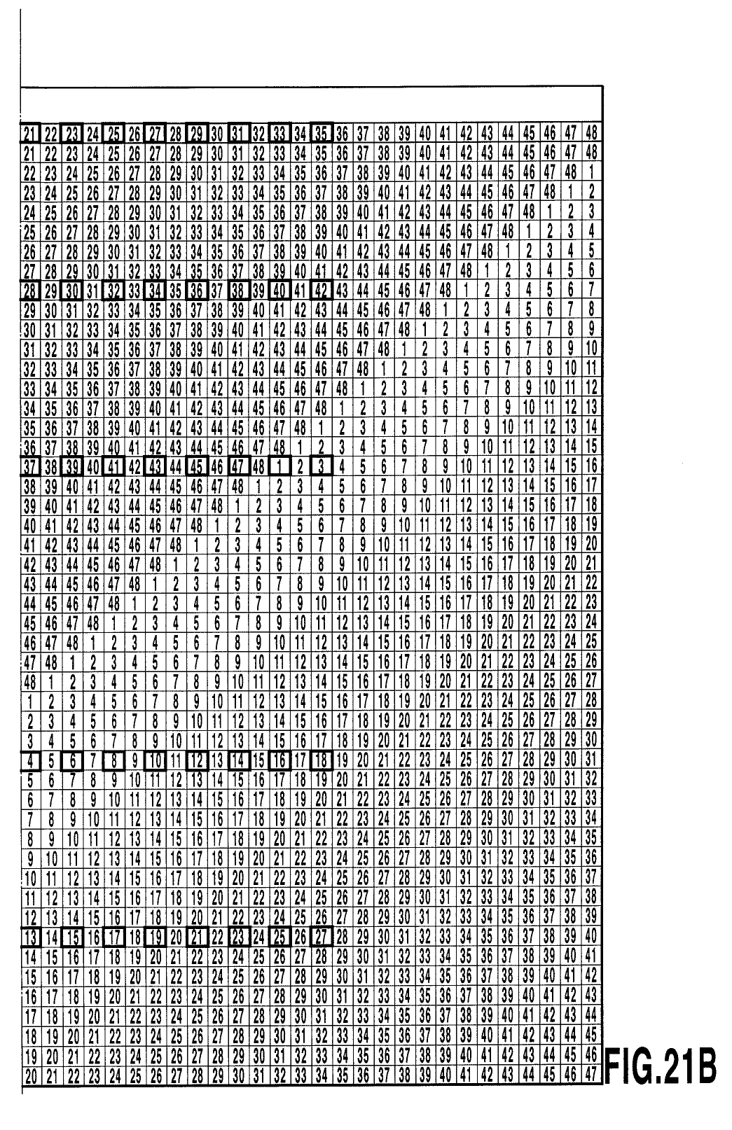

Table 5 of FIGS. 20A and 20B and Table 6 of FIGS. 21A and 21B each show an arrangement example of the substantially functioning input/output ports of the AWG 20 in the optical power monitor of an embodiment 4 in accordance with the present invention. Here, the description will be made by way of example of the optical power monitor used for the ROADM system with 48 wavelength channels as in the embodiments 2 and 3.

Table 5 of FIGS. 20A and 20B shows a case where part of the substantially functioning output ports 22 includes a skipped disposition on the output port side. On the other hand, Table 6 of FIGS. 21A and 21B shows a case where both the substantially functioning input ports 21 and output ports 22 include a skipped disposition.

As for the installation of the CSP type PD array module 50 shown in FIGS. 11(a) and 11(b) described in connection with the embodiment 3, since it requires the optical path changing mirror 71 at the end of the output waveguides 22, its assembling process is complicated. In view of this, in the configuration of FIG. 9, an arrangement example of the input/output ports capable of reducing the cross talk is shown in Table 5 or 6. It will be described below by way of example of Table 5 of FIGS. 20A and 20B.

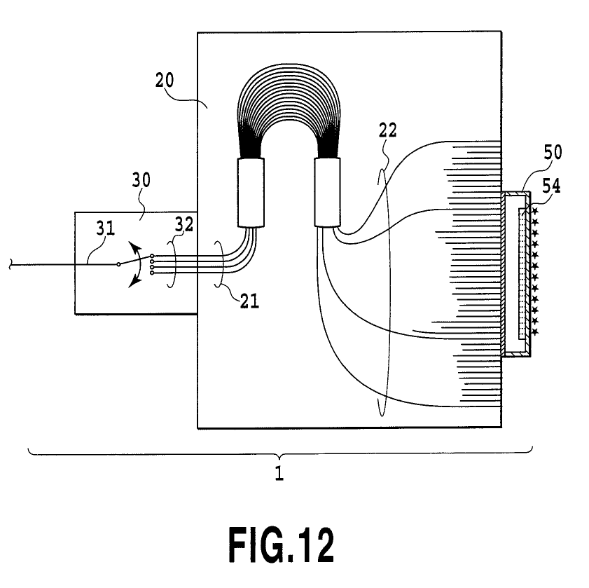

FIG. 12 shows a configuration of the optical power monitor of the embodiment 4 in accordance with the present invention. On the input port side, the input ports 21 are shown by the number of the substantially functioning ports, and on the output port side, all the output ports 22 are shown to facilitate understanding.

The substantially functioning output ports 22 of the AWG 20 of the present embodiment are placed every second port from the output port number #13 to #36 (ports designated by an asterisk in FIG. 12). On the other hand, a CSP type PD array module 50 including a 24-channel PD array 54 is used as the PDs. In this case, they are installed in such a manner that the pitch of the 24 ports from the output port #13 to #36 of the AWG agrees with the pitch of the photosensitive surfaces 53 of the 24-channel PD array 54. In this way, optical signals emitted from the non-substantially functioning output waveguides drawn out of the end face of the second slab waveguide are absorbed by the photosensitive surfaces of the non-substantially functioning dummy PDs. This enables the photosensitive surfaces to absorb and terminate the cross talk light. Accordingly, the degradation in the characteristics of the optical power monitor can be reduced as compared with the case of FIG. 10A where it is feared that the spurious signal light can fall on the regions other than the photosensitive surfaces of the PDs. As for Table 6 of FIGS. 21A and 21B, the deterioration in the characteristics of the optical power monitor can be reduced for the same reason. Although the present example is described by way of example where the substantially functioning output ports 22 are placed every second ports, this is not essential. For example, a configuration is also possible where they are placed at every third or more ports.

What is important here is to place the substantially functioning output ports 22 every second ports or more ports, and to select the substantially functioning input ports 21 in such a manner that the substantially functioning output ports 22 emit the optical signals with desired wavelengths. Then, by selecting the input/output ports, the pitch of the substantially functioning output ports and adjacent non-substantially functioning output ports is implemented in such a manner as to agree with the pitch of the photosensitive surfaces 53 of the PD array 54 having the same number of channels as these output ports. This enables the photosensitive surfaces to absorb and terminate the cross talk light, thereby being able to reduce the deterioration in the characteristics of the optical power monitor.

### Embodiment 5

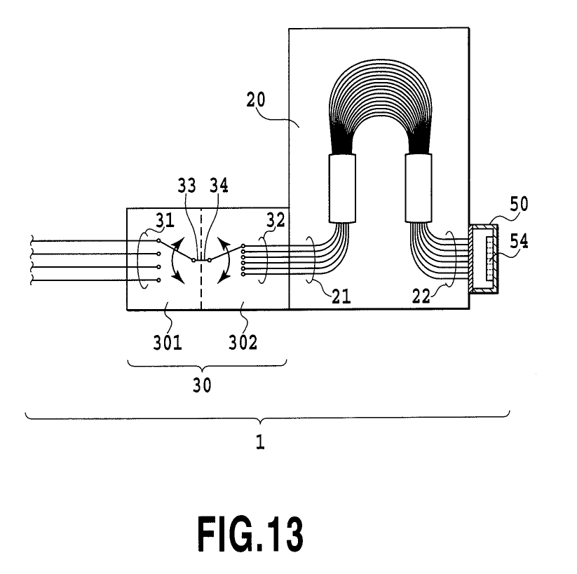

FIG. 13 shows a configuration of the optical power monitor of an embodiment 5 in accordance with the present invention. The present embodiment combines the embodiments described so far to further simplify the configuration of the optical power monitor applied to the ROADM system, and to push the miniaturization and cost reduction forward. The optical power monitor described in connection with the embodiment 1, which integrates the optical power monitors placed at a plurality of locations into one unit by introducing the optical switch, demonstrates that it can reduce the numbers of the DMUXs and PDs. In addition, the optical power modules described in connection with the embodiments 2-4 demonstrate that they can reduce the number of PDs, which is necessary by the number of the wavelength channels in the conventional configuration, by introducing the optical switch. Furthermore, the present embodiment shows that it can simplify the configuration of the optical power monitor by the combined effect of integrating the two types of the embodiments, thereby being able to implement the miniaturization and cost reduction.

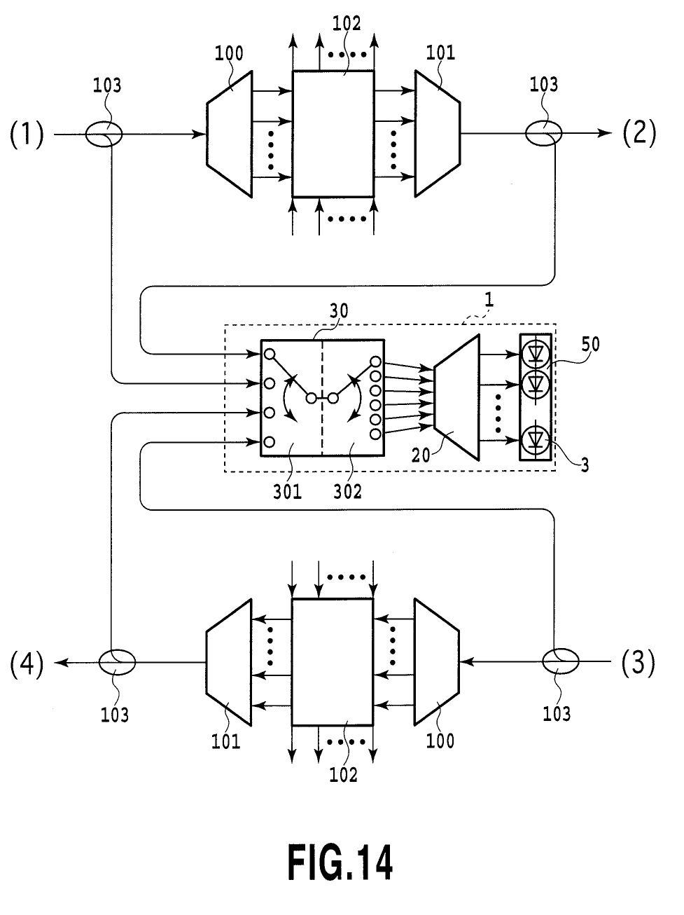

Here, the description will also be made by way of example of the optical power monitor used for the ROADM system with 48 wavelength channels. In addition, as the monitoring position of the WDM signal, let us take an example that monitors the optical signal power of each wavelength channel at the inlet ((1) or (3) in FIG. 1) or outlet ((2) or (4) in FIG. 1) of the node as shown in FIG. 14. Thus, an example that monitors at four positions will be described here. The portion enclosed by broken lines in FIG. 14 corresponds to the optical power monitor 1 shown in FIG. 13.

As shown in FIG. 13, the optical power monitor 1 comprises an optical switch 30 having four input ports 31 and six output ports 32 implemented by a PLC; a 48×48 AWG 20 having six substantially functioning input ports 21 and eight substantially functioning output ports 22, which is also implemented by the PLC; and eight PDs 3. The eight PDs will be described by way of example of the CSP type PD array module 50 including the 8-channel PD array 54. The output ports 32 of the optical switch 30 are each optically connected to the input ports 21 of the AWG 20. In addition, the output ports 22 of the AWG 20 are optically connected to the photosensitive surfaces 53 of the PDs included in the CSP type PD array module 50 which are mounted on the end faces of the output waveguides 22 of the AWG 20. The four input ports 31 of the optical switch 30 are optically connected to couplers 103 that split the WDM signals fed from (1) and (3) of FIG. 14 and the WDM signals output to (2) and (4) of FIG. 14, which are the monitoring positions of the WDM signals.

The details of the optical switch employed in the present embodiment will be described here. The optical switch 30 is considered to have a two-stage construction. More specifically, a first stage is a first optical switch 301 that operates to select one of the WDM signals flowing through (1)-(4) of FIG. 14 which are the monitoring positions. The first optical switch 301 takes charge of the functions described in the embodiment 1. A second stage is a second optical switch 302 that operates to select one of the input ports of the AWG 20 so that 48 optical signals multiplexed into the WDM signal is demultiplexed by the AWG 20 and the individual wavelengths are received by the 8-channel PDs. The second optical switch 302 takes charge of the functions in the embodiments 2-4. More specifically, the present embodiment is characterized by integrating the first optical switch 301 and the second optical switch 302. In the PLC, in particular, since the first optical switch 301 and the second optical switch 302 can be fabricated with integrating them simultaneously, the construction is very effective for the miniaturization of the optical power monitor 1.

Next, the details of the AWG 20 constructed in the present embodiment will be described. As the structure of the AWG 20, the present embodiment employs the construction used in the embodiment 2. More specifically, the AWG 20, which is an AWG originally designed with the input of 48 channels and the output of 48 channels, is assumed as shown in Table 2 of FIGS. 17A and 17B that the six input waveguides 21 such as the input ports #5, #13, #21, #29, #37, and #45 placed at every eight port interval are each optically connected to the six output waveguides 32 of the second optical switch 302, and the consecutive eight output waveguides 22 consisting of the output ports #21, #22, #23, #24, #25, #26, #27, and #28 are each optically connected to the PDs.

Next, a method of monitoring the WDM signal will be described. For example, assume that the optical powers of the individual wavelength channels of the WDM signal flowing through (1) of FIG. 14 are to be monitored. In this case, the first optical switch 301 is operated in such a manner that among the four input ports 31 of the optical switch 30, the input port connected to (1) of FIG. 14 is connected to the output port 33 of the optical switch 30. Thus, only the WDM signal flowing through (1) of FIG. 14 is selected to be supplied to the second optical switch 302, which selects one of the six input ports of the AWG 20. For example, assume that the optical powers λ25-λ32 of the light wavelength signal are to be monitored. In this case, the second optical switch 302 is operated in such a manner that the output port 32 of the second optical switch 302, which is connect to the input port #5 of the AWG 20, is connected. Thus, in the WDM signal which is input to the AWG 20 and demultiplexed, the light wavelength signals λ25-λ32 are supplied to the output ports #21 to #28 of the AWG 20. After that, the light wavelength signals λ25-λ32 are received by the PDs 3, respectively. Next, when the second optical switch 302 is operated in such a manner that the output port of the second optical switch, which is connected to the input port #13 of the AWG 20, is connected, the optical signals from λ33 to λ40 of the light wavelength signal are emitted from the output ports #21 to #28 of the AWG 20, respectively, this time. Then, the optical signals are received by the PDs 3, respectively.

Likewise, operating the second optical switch 302 makes it possible to monitor all the optical powers of the individual wavelength channels of the WDM signal on an eight wavelength basis. Furthermore, to monitor the optical powers of the individual wavelength channels of the WDM signal flowing through (2)-(4) of FIG. 14, the first optical switch 301 is operated successively in addition to operating the second optical switch 302 successively. Thus, all the optical powers of the individual wavelength channels can be monitored.

As to the order of monitoring the optical power at the four positions, it is not necessary to carry out in order, and the order of monitoring the optical power depends on the monitoring algorithm of the WDM system. Accordingly, random monitoring is also possible, or monitoring of a particular light wavelength signal at a particular monitoring position is also possible by freely selecting the combination of the first optical switch 301 and the second optical switch 302.

As described above, according to the present invention, the optical power monitors, which must be placed at a plurality of positions conventionally, can be reduced to only the single position by introducing the optical switch 30. In addition, the number of the PDs can be reduced greatly. For example, in the conventional example as shown in FIG. 1, since the optical power monitors 1 are placed at the four positions each, four AWGs 20 and as many as 24 CSP type PD array modules 50 each including the 8-channel PD array are required. In contrast with this, as shown in FIGS. 13 and 14, the present embodiment requires only one AWG 20, and only one CSP type PD array modules 50 including the 8-channel PD array, thus being able to reduce the number of the major components greatly. In addition, since the number of the electronic components such as logarithmic amplifiers mounted after the PDs can be reduced accordingly in practice, it is possible to greatly reduce not only the components, but also the assembling cost.

As the optical switch 30 employed in the foregoing embodiments 1-5, the optical switch implemented by a PLC is supposed as an example. The major optical switches implemented by the PLCs are those that achieve the switching operation based on thermooptic (TO) effect by using a Mach-Zehnder interferometer as a circuit component.

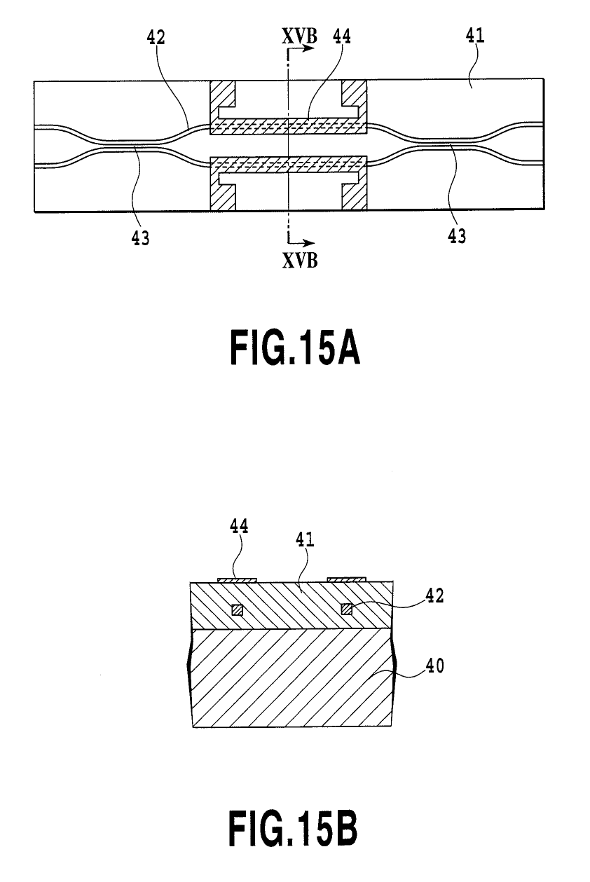

FIG. 15A shows a basic structure of the optical switch, and FIG. 15B shows a cross-sectional view taken along the line XVB-XVB. Generally, a PLC 41 is formed on a silicon substrate 40. Thin film heaters 44 are loaded over waveguides 42 between two couplers 43. The switching operation of the optical switch is implemented by varying the refractive index of the waveguides 42 by the TO effect caused by supplying power to the thin film heaters 44. The optical switch having a plurality of inputs and a plurality of outputs can be implemented by constructing a tree configuration or a tap configuration using the basic structures of the switch.

In addition, it goes without saying that the present invention can improve the characteristics of the optical switch by making the basic structure of the switch a double gate structure for improving the extinction ratio of the optical switch, or by incorporating a heat-insulating groove structure for reducing the power of the optical switch. In particular, the present invention can not only facilitate the integration of the AWG and the optical switch by implementing both of them by the PLC but also miniaturize the monitor. As a fabrication method of the optical switch and the AWG based on the PLC, after fabricating the optical switch and the AWG independently, the output waveguides of the optical switch and the input waveguides of the AWG can be connected optically, or the optical switch and the AWG can be monolithically integrated on the same wafer.

It goes without saying that the configurations described in the embodiments 1-5 are only examples, and all the configurations that fall within the scope intended by the present invention are included. For example, the number of the wavelength channels and the number of positions to be monitored the WDM system handles are not limited in anyway. Accordingly, in the optical power monitor in accordance with the present invention, the numbers of the input ports 31 and 34 and output ports 32 and 33 of the optical switch 30, and the numbers of the input ports 21 and output ports 22 of the AWG 20 depend on the design of the WDM system. This also applies to the number of the PDs.

Besides, as for the configuration as shown in FIGS. 11(a) and 11(b), which places the optical path changing mirror at the end of the output waveguides and mounts the PDs thereover, it is not limited to that described in the embodiment 3. Thus, there is no problem in applying such a mounting construction of the PDs to the optical power monitors described in the embodiments 1-5 as needed.

Furthermore, as for the arrangement of the substantially functioning input ports 21 and output ports 22 of the AWG 20 shown in Tables 1-6 of FIGS. 16-21, they are not limited to these arrangements. It is enough for the arrangement of the substantially functioning input ports 21 and output ports 22 to be a combination that enables the PDs to receive the light wavelength signals of the individual wavelength channels to be monitored by the optical power monitor 1.

The combinational arrangement in the embodiment 2 is described by way of arrangement that employs #5, #13, #21, #29, #37, and #45 as the substantially functioning input ports, and #21, #22, #23, #24, #25, #26, #27, and #28 as the substantially functioning output ports. However, the combination can be changed to that which employs #4, #10, #16, #22, #28, #34, #40, and #46 as the substantially functioning input ports and #4, #5, #6, #7, #8, and #9 as the substantially functioning output ports. Besides, any other combinations among a lot of combinations can be employed. The foregoing embodiments 2-5 are only examples of the combinations.

Although the foregoing embodiments in the present specification are described by way of example of the optical power monitor, this is not essential. For example, the embodiments can function as a wavelength monitor by introducing the function of detecting the wavelength information.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An optical signal monitoring apparatus comprising:
an optical switch with at least one of input port and output port in plural form;
a wavelength demultiplexer that has at least one input port and a plurality of output ports, and has its input port optically connected to the output port of said optical switch; and
a photo diode array mounted on the output ports of said wavelength demultiplexer.

2. The optical signal monitoring apparatus of claim 1, wherein said the output ports of said wavelength demultiplexer and said photo diode array are implemented via an optical path conversion mirror.

3. The optical signal monitoring apparatus of claim 1, wherein said plurality of photo diodes consisted of said photo diode array are optically connected to the output ports of said wavelength demultiplexer being spaced at a prescribed wavelength channel interval.

4. The optical signal monitoring apparatus of claim 2, wherein said plurality of photo diodes consisted of said photo diode array are optically connected to the output ports of said wavelength demultiplexer being spaced at a prescribed wavelength channel interval.

5. The optical signal monitoring apparatus of claim 3, wherein dummy photo diodes are placed among the plurality of photo diodes consisted of said photo diode array.

6. The optical signal monitoring apparatus of claim 4, wherein dummy photo diodes are placed among the plurality of photo diodes consisted of said photo diode array.

7. An optical system having a configuration of monitoring a WDM signal at a plurality of positions, said optical system comprising:
a plurality of branching sections for branching a part of the WDM signal at each monitoring position; and
the optical signal monitoring apparatus as defined in claim 1, which is optically connected to each of said plurality of branching sections respectively.
